(19) United States
(12) Patent Application Publication
(10) Pub. No.: US 2017/0246776 A1
(43) Pub. Date: Aug. 31, 2017

(54) FOAMING DIE AND METHOD OF USE

(71) Applicant: 3M INNOVATIVE PROPERTIES COMPANY, St. Paul, MN (US)

(72) Inventors: Jeffrey P. Kalish, St. Paul, MN (US); James M. Jonza, Woodbury, MN (US); Brian L. Koster, Cottage Grove, MN (US); Bryan C. Feisel, Hudson, WI (US)

(21) Appl. No.: 15/517,049

(22) PCT Filed: Oct. 20, 2015
(86) PCT No.: PCT/US2015/056397

§ 371 Date: Apr. 5, 2017

Related U.S. Application Data
(60) Provisional application No. 62/067,888, filed on Oct. 23, 2014.

(51) Int. Cl. B29C 44/46; B29C 47/56; B29C 47/36; B29C 47/00; B29C 47/14

(52) U.S. Cl. CPC B29C 44/468; B29C 47/0019; B29C 47/0045; B29C 47/14; B29C 47/366; B29C 47/56; B29K 2105/04

(57) ABSTRACT

Foam slabs and methods and apparatus, including foaming dies, for making and using foam slabs.

### BACKGROUND

Foamed articles have found wide use in various applications, thermal or acoustic insulation, reinforcing layers and/or space-filling layers, and so on.

### SUMMARY

In broad summary, herein are disclosed foam slabs and methods and apparatus, including foaming dies, for making and using foam slabs. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front-side perspective view of an exemplary foaming die.

FIG. 2 is a schematic view of an exemplary extrusion apparatus with which a foaming die may be used.

FIG. 3 is a front plan view of an exemplary working face of an exemplary foaming die.

FIG. 4 is a magnified front plan view of several die orifices of the exemplary foaming die of FIG. 3.

FIG. 5 is a front-side perspective view of an exemplary foam slab being produced from an exemplary foaming die.

FIG. 6 is a front plan view of another exemplary working face of an exemplary foaming die, bearing two rows of orifices.

FIG. 7 is a front plan view of another exemplary working face of an exemplary foaming die, bearing dogbone-shaped die orifices.

FIG. 8 is a front plan view of another exemplary working face of an exemplary foaming die, bearing a first set of die orifices and a second set of die orifices.

FIG. 9 is a front plan view of an exemplary multilayer molten flowstream being emitted from an exemplary set of die orifices.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). For angular orientations, the term “generally” means within clockwise or counterclockwise 30 degrees. The term “substantially”, unless otherwise specifically defined, means to a high degree of approximation (e.g., within +/−10% for quantifiable properties). For angular orientations, the term “substantially” means within clockwise or counterclockwise 10 degrees. The term “essentially” means within plus or minus 2% (plus or minus 2 degrees for angular orientations), and it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. Those of ordinary skill will appreciate that as used herein, terms such as “essentially free of”, and the like, do not preclude the presence of some extremely low, e.g. 0.1% or less, amount of material, as may occur e.g. when using large scale production equipment subject to customary cleaning procedures. All references herein to numerical parameters (dimensions, ratios, and so on) are understood to be calculable (unless otherwise noted) by the use of average values derived from a number of measurements of the parameter, particularly for the case of a parameter that is variable (e.g., for an orifice whose width varies along the long axis of the orifice, the width of the orifice may be measured at several locations along the long axis of the orifice and an average value used for purposes of calculating an aspect ratio).

### DETAILED DESCRIPTION

Glossary

By a foaming die is meant an extrusion die that is configured to withstand the pressures present in the extrusion of a molten foamable flowstream. By definition a foaming die comprises at least one die cavity configured to receive a molten flowstream e.g. from an extruder, and comprises a plurality of die orifices in fluid communication with the at least one die cavity.

By a molten foamable flowstream is meant a molten flowstream that comprises a molten foamable composition. In some cases such a flowstream may be a multilayer flowstream in which e.g. only one layer of the flowstream comprises a foamable composition.

By a molten foamable composition is meant a molten thermoplastic organic polymeric material that comprises a blowing agent (e.g., a physical blowing agent such as a gas or liquid; or, a chemical blowing agent that may chemically decompose e.g. at an elevated temperature, as discussed in detail later herein).

By non-foamable is meant a molten composition that is at least essentially free of activatable blowing agent (e.g., so that a solidified product of the molten composition is a non-foam material with a relative density that is at least essentially equal to 1.0.)

By a foam is meant an organic polymeric foam obtained by solidifying a molten foamable composition after the foaming process has proceeded to a desired extent.

By a foam slab is meant a foam entity with a length and a long axis, a lateral width and a lateral axis, and a thickness and a thickness axis, the three axes being orthogonal to each other and with the slab width being greater than the slab thickness. By definition, a foam slab is at least essentially compositionally uniform along the long axis of the slab. A foam slab admits the presence of densified (e.g. non-foam) material as a portion of the slab, as long as the densified material is made in the same operation as the foam portion of the slab, so that the portions collectively make up a unitary slab.

By unitary is meant an entity (e.g., a foam slab) that is made in a single operation by the coalescence and solidification of molten flowstreams and that cannot be separated into parts without unacceptably damaging or destroying the entity. A unitary entity may be a composite entity, as long as all portions (e.g. layers, members, etc.) of the entity were made and brought together with each other in a single (e.g. coalescing/solidifying) operation so that the portions cannot be separated from each other are not removable from each other.

By a composite foam slab is meant a unitary foam slab that comprises, in addition to a major foam phase, at least one minor foam phase comprising a densified material.

The term densified is used to distinguish a minor phase of a composite foam slab from a major, foam phase of the composite foam slab, and means that the minor phase exhibits a relative density that is at least about 15% higher than that of the major, foam phase. The term “densified” is used for convenience of description and does not signify that a “densified” material cannot be a foam, nor does it require that a densified material must be a material that was first made at a lower density and then processed to increase its density.

Relative density (e.g. of a foam material) is a dimensionless parameter obtained by dividing the overall density of a material (e.g., a foam comprising air-filled cells) by the density of the substance that makes up the cell walls of the material. Relative density is sometimes referred to as reduced density. For e.g. a polyester foam comprising a density of 0.5 g/cc and that comprises cell walls made of polyester that has a density of 1.35 g/cc, the relative density is about 0.37. For a conventional non-foam (and non-porous) material, the relative density will be at least essentially equal to 1.0.

Various terms relating to die orifice geometries and patterns (e.g., die height, die lateral axis, orifice height, and the meaning of such terms as laterally-adjacent, laterally-aligned, and laterally-coalesced), are defined and described in detail later herein, augmented by reference to various Figures.

Foaming Die

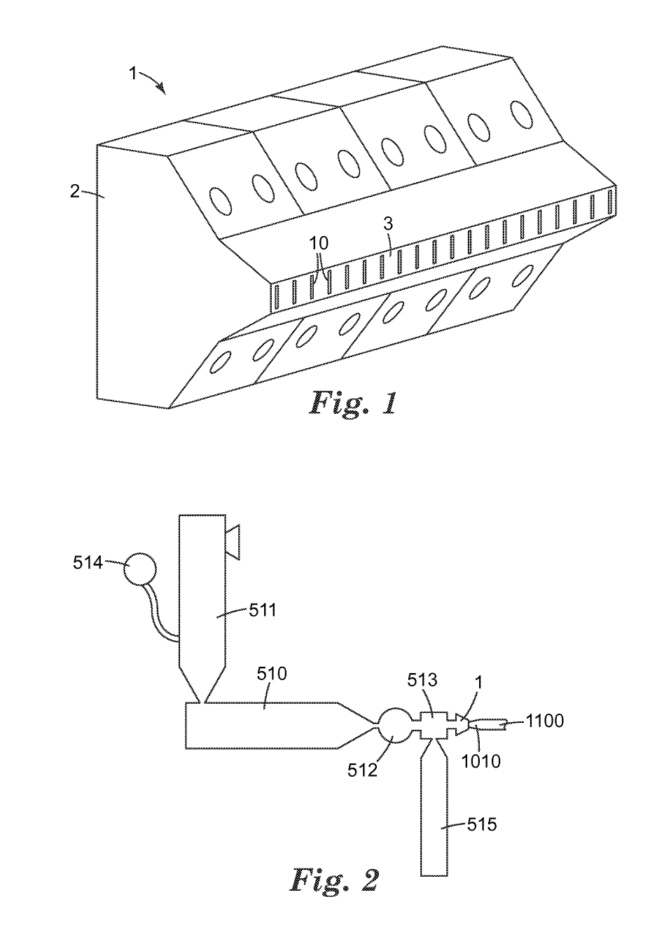

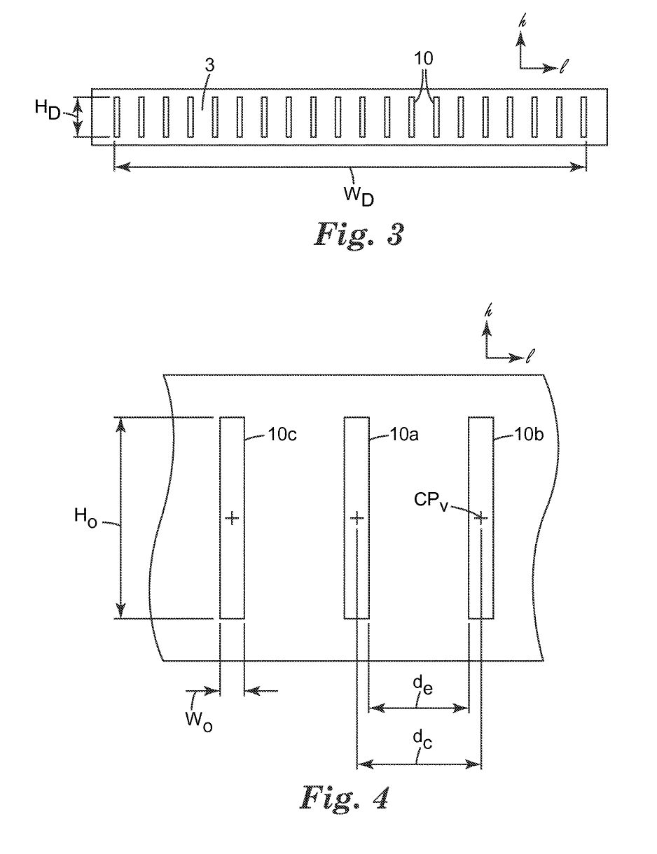

Disclosed herein is a foaming die 1 as shown in exemplary embodiment in FIG. 1. Foaming die 1 may be used with any suitable extrusion apparatus, as shown in exemplary embodiment in FIG. 2 and as discussed in detail later herein. Foaming die 1 comprises a main body 2 that comprises a working face 3. As shown in the front plan view of FIG. 3, working face 3 comprises a plurality of die orifices 10.

With respect to the exemplary arrangement shown in FIG. 3, die orifices 10 are spaced along a lateral axis (l) of die 1 so as to establish a die width (W_{D}). The die width (W_{D}) is defined as the distance, between the farthest-apart edges of die orifices, along the lateral axis of the die. Die orifices 10 also establish a die height (H_{D}), which is defined as the distance, along the height axis (h) of the die, between the farthest-apart locations of die orifices (i.e., between the “uppermost” and “lowermost” edge of die orifices, as shown in exemplary embodiment in FIG. 3). The height axis (h) of die 1 by definition is orthogonal to the lateral axis (l) of die 1 (both the height axis (h) and the lateral axis (l) are orthogonal to the direction of extrudate flow out of the die orifices, which direction is out-of-plane in FIGS. 3 and 4). The term height as used e.g. in the terms height axis and die height, the term vertical as used to denote a direction along the height axis, and terms such as upper/uppermost and lower/lowermost as used e.g. to denote locations along the height axis, are used purely for convenience of description with respect to the exemplary Figures presented herein, and do not require any specific orientation with regard to the Earth. (It will be apparent in later discussions that the “height” axis (h) of foaming die 1 corresponds to the “thickness” axis (t) of a foam slab made by the use of foaming die 1.)

By definition, the die width (W_{D}) (along the lateral axis of the die, along which axis the die orifices are spaced) is greater than the die height (H_{D}). In various embodiments, the ratio of die width to die height can be at least about 1.1, 1.2, 1.5, 2.0, 4:1, 8:1, or 12:1. In further embodiments, the ratio of die width to die height can be at most about 50:1, 30:1, or 20:1. In various embodiments, die 1 may exhibit a die height of at least about 4.0, 8.0, 12, 16, 20, 30, or 40 mm. In further embodiments, die 1 may exhibit a die height of at most about 80, 40, 30, 25, or 20 mm. In various embodiments, die 1 may exhibit a die width of at least about 2.0, 4.0, 8.0, 10, 20, 40, 100 cm, or of at least about 0.5, 1.0, or 2 meters. In further embodiments, die 1 may exhibit a die width of at most about 3, 2, 1, or 0.5 meters, or 100, 80, 60, 50, 40, 30, 25, or 20 cm.

Die orifices can be present at any desired center-to-center spacing (d_{c}), as shown for an exemplary orifice pattern in FIG. 4), as long as the conditions of lateral alignment that are discussed herein are met. In various embodiments, the center-to-center spacing (d_{c}) may be e.g. at most about 25, 20, 15, 10, 8, 6, 4, 2, or 1 mm. In further embodiments, the center-to-center spacing may be at least about 0.5, 1, 1.5, 2, 2.5, 4, 6, 8, 10, or 15 mm. The center-to-center spacing is not necessarily required to be constant amongst various orifices; thus, the center-to-center spacing may be an average. In various embodiments, the total number of die orifices may be at least about 10, 20, 30, 40, 80, 100, 200, 400, or 800. In further embodiments, the total number of die orifices may be at most about 5000, 2000, 1200, 1000, 600, 400, or 200.

By definition, die orifices 10 exhibit an elongated shape with a long axis that is at least substantially aligned with the height axis (h) of die 1, and that is at least substantially orthogonal to the lateral axis (l) of die 1. Here and elsewhere, the term substantially aligned, as used with respect to an angular alignment, means within plus or minus 15 degrees of exactly aligned. Similarly, the term substantially orthogonal means within plus or minus 15 degrees of exactly orthogonal. In various embodiments, a die orifice may exhibit a long axis that is aligned within plus or minus 10 degrees, or plus or minus 5 degrees, of the height axis (h) of die 1. In some embodiments, (e.g. as shown in FIGS. 3 and 4) the long axis of a die orifice may be at least essentially aligned with the height axis (h) of die 1 and at least essentially orthogonal to the lateral axis (l) of die 1. This is not strictly required, however. Moreover, all the die orifices need not necessarily share the exact same shape, height, width, aspect ratio, angular orientation relative to the height axis (h) of the die, and so on. However, in some embodiments (e.g. as pictured in FIG. 3), at least some die orifices may share at least essentially identical heights and/or shapes, and/or may be at least essentially uniformly spaced along the lateral axis of the die, and/or may share at least essentially the same angular orientation.

With reference to FIG. 4, in various embodiments a die orifice may exhibit an orifice width (Wₒ) of at least about 0.2, 0.4, 0.5, 0.6, 0.8, 1.0, 1.5, or 2.0 mm. In further embodiments, a die orifice may exhibit an orifice width (Wₒ) of at most about 4, 3, 2, 1.5, 1.0, 0.8, 0.7, or 0.6 mm. In various embodiments, a die orifice may exhibit an orifice height (Hₒ) (meaning the end-to-end distance measured along the long axis of the die, as shown in FIG. 4) of at least about 4, 8, 12, 16 or 20 mm. In further embodiments, a die orifice may exhibit an orifice height (Hₒ) of at most about 100, 80, 40, 30, 25, or 20 mm. In some embodiments (e.g., of the general type depicted in FIG. 3) the orifice height of all of the orifices may be the same and may equal the die height. However, this is not strictly necessary.

In various embodiments, a die orifice may exhibit an aspect ratio of orifice height (Hₒ) to orifice width (Wₒ) of at least about 4:1, 6:1, 8:1, 10:1, or 12:1. The orifice width (Wₒ) is measured along a direction at least substantially aligned with the lateral axis of the die; if the width varies along the height (i.e., long axis) of the orifice, an average value of the orifice width may be used in calculating the aspect ratio. It is emphasized that a requirement that a die orifice exhibit an elongated shape and a long axis, and that it exhibit a height/width aspect ratio, does not necessitate that the orifice must be strictly linear (or that it must have e.g. strictly straight walls), as long as a recognizable long axis, height and width can be identified by a person of ordinary skill. That is, if desired a die orifice may be e.g. oval, arcuate (e.g., banana-shaped), and so on. In some embodiments, at least some orifices may comprise a generally “dogbone” shape. This denotes a shape in which the width (Wₒ) of the orifice in a location proximate a first terminal end (e.g., an upper end) of the orifice, and the width of the orifice in a location proximate a second terminal end (e.g. a lower end) of the orifice, are each larger than the width of the orifice in a section of the orifice that is centrally located along the long axis of the orifice (and thus along the height axis (h) of the die). Exemplary dogbone-shaped die orifices are shown in FIG. 7. In various embodiments the ratio of an orifice width at an end-proximate location of an orifice, to the width of the orifice at a central location, may be at least about 1.2, 1.4, 1.6, 1.8, 2.0, 2.5, or 3.0 to 1.0.

Laterally-Aligned Pattern of Die Orifices

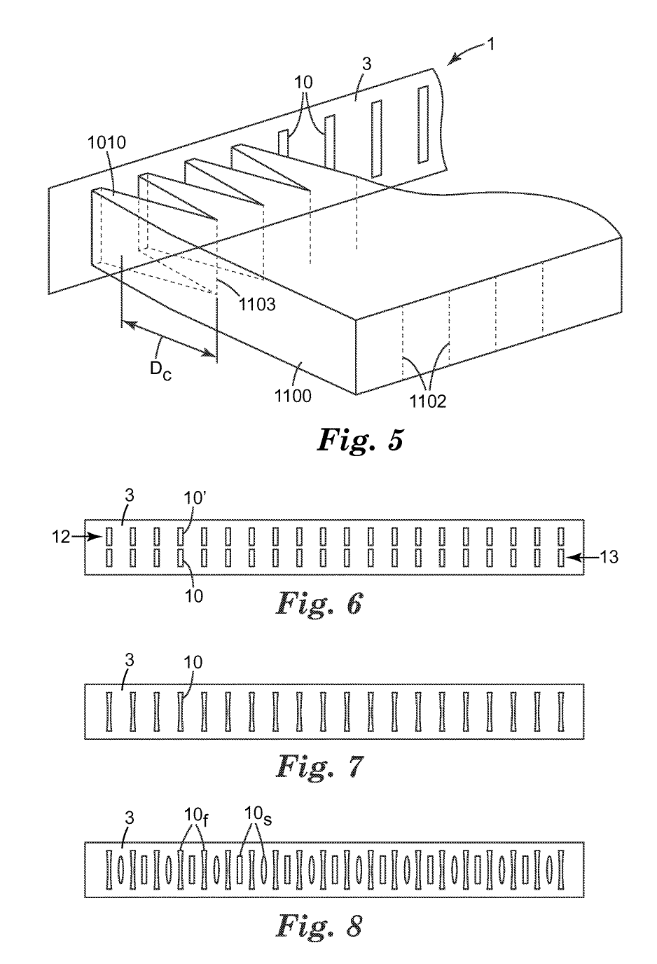

Die orifices 10 are spaced along the lateral axis of die 10 so that they are in a laterally-aligned pattern. The advantages of such an arrangement can be appreciated by inspection of the (idealized) representation of FIG. 5, which shows an exemplary unitary foam slab 1100 being produced by the coalescing and solidification of molten foamable extrudate flowstreams 1010 that are emitted from orifices 10 of die 1. The ordinary artisan will appreciate that the emitting of molten foamable extrudate flowstreams 1010 from a plurality of die orifices that are spaced along a lateral axis of the foaming die in a laterally-aligned pattern, which orifices have a long axis oriented at least substantially along the height axis of the die, results in foam slab 1100 being formed primarily by lateral coalescence of the molten foamable extrudate flowstreams. That is, foam slab 1100 is formed primarily by way of the molten flowstreams expanding (due in large part to the foaming that commences upon the streams exiting the die orifices) and spreading laterally (right and left in the depiction of FIG. 5) so as to meet each other and coalesce.

Such an orifice arrangement and the use thereof, and the resulting foam slab product, will be distinguished from arrangements in which a foam slab is produced by emitting a molten foamable extrudate flowstream through a small number of slot orifices (e.g., one orifice) that have a long axis oriented along the lateral axis of a die (e.g., as in a conventional “coathanger” style die/orifice). The ordinary artisan will appreciate that little or no lateral coalescence may occur in the use of such a “coathanger” style die/orifice design.

The arrangements disclosed herein may also be distinguished e.g. from an arrangement in which a foam slab is produced by emitting molten foamable extrudate flowstreams through a number of die orifices (of e.g. a perforated metal “die plate” comprising a large number of orifices e.g. in an array of multiple rows and columns) that are not laterally-aligned. The ordinary artisan will appreciate that such a design may cause the molten flowstreams to merge and coalesce to a significant extent e.g. in directions at least generally along the height axis of the die rather than coalescing in a direction primarily along the lateral axis of the die. One such conventional die plate arrangement that does not involve laterally-aligned die orifices as disclosed herein, is described e.g. in U.S. Pat. No. 3,573,152 to Wiley. The ordinary artisan will appreciate based on the disclosures herein that laterally-aligned orifice arrangements as disclosed herein may provide several advantages, including e.g. increased uniformity of the foam slab product, increased bending stiffness and/or resistance to delamination when the foam slab is bent along its long axis, and so on.

Methods of using die 1 to make foam slab 1100 may be characterized by a coalescence distance (D_{c}), which is illustrated in FIG. 5 in an idealized and exemplary manner. The coalescence distance (D_{c}) is the distance (on average) from the die orifices 10, along the direction of flow of the molten flowstreams, at which laterally neighboring molten flowstreams 1010 contact each other (e.g. at location 1103) so as to merge and coalesce to form slab 1100. The coalescence distance (D_{c}) may of course be affected by the lateral spacing of the die orifices. However (e.g. for a given orifice spacing) the coalescence distance (D_{c}) may be adjusted e.g. by the throughput rate of extruded material and also e.g. by the takeaway speed (e.g. in the case that the foam slab is collected on a moving belt or between moving belts). The coalescence distance (D_{c}) may be adjusted to any desired value by any or all of these apparatus configurations and/or operating conditions. Under some circumstances it may be advantageous to minimize the coalescence distance (D_{c}), e.g. to bring molten flowstreams into contact with each other when the surfaces of the flowstreams are still sufficiently hot to promote excellent bonding (e.g. melt-bonding) therebetween, to ensure that no hollow channels are present in the foam slab (as discussed below) and so on. In various embodiments, the coalescence distance (D_{c}) may be less than about 50, 40, 30, 10, 4, 2, or 1 mm.

With further reference to FIG. 5, meeting-points 1103 at which adjacent flowstreams 1010 contact each other, may give rise to identifiable interfacial boundaries 1102 in the final, foam slab. However, due to e.g. lateral spreading that may occur in the foaming process, in some embodiments such interfacial boundaries 1102 may be spaced further apart (across the lateral width of the foam slab) than the spacing of the die orifices 10 from which the adjacent flowstreams 1010 originated.

It will be appreciated based on the Working Examples that the disclosures herein allow the production of unitary foam slabs that exhibit few or no internal macroscopic hollow (e.g., air-filled) elongate channels that extend along the long axis of the formed slab. (In some circumstances such channels might form, either unintentionally or by design, due to the failure of the surfaces of at least some of the molten foamable extrudate flowstreams to fully contact surfaces of other flowstreams before solidification of the flowstreams occurs.) A unitary foam slab that exhibits few or no such channels will be termed a non-channeled foam slab. (An internal macroscopic hollow elongate channel that extends along the long axis of the slab is not to be confused with an actual cell of a foam; also, slight irregularities along a major surface or minor edge of the foam slab are not considered to be an internal channel.) A non-channeled slab is one that if cut in cross-section along a plane orthogonal to the long axis (extrusion direction) of the slab, will exhibit essentially no (that is, less than 1% on average, measured as a percentage of the total area of the cross-sectionally exposed surface) such internal macroscopic hollow elongate channels. Thus in at least some embodiments, a unitary foam slab as disclosed herein (which may be a composite slab) is a non-channeled unitary foam slab.

The ability to, if desired, produce non-channeled foam slabs is surprising considering that the extrusion of a molten foamable flowstream through an elongate die orifice (e.g., a slot) is known to the ordinary artisan to give rise to a phenomenon called “corrugation”, in which the emitted molten extrudate flowstream exhibits crumpling or waviness as it foams. This phenomenon is conventionally thought to be due to the molten extrudate flowstream being at least somewhat restricted from being able to expand in a direction along the long axis of the orifice (since it is prevented from doing so by the molten material that neighbors it in that direction), thus causing the molten stream to “corrugate” along this axis. In the present work, non-channeled foam slabs have been reliably produced, indicating that positioning elongate die orifices laterally adjacent to each other as described herein may provide that any such corrugating that may occur nevertheless does not prevent the molten flowstreams from merging and coalescing to produce a non-channeled foam slab.

With reference to FIG. 5, it will be appreciated that the herein-disclosed arrangements may provide certain relationships between various geometric parameters of the die orifice pattern and geometric parameters of the foam slab formed by emitting molten foamable flowstreams therefrom. In various embodiments, a slab thickness of the foam slab may be at least (on average) greater than the die height, by a factor of at least about 2%, to at most about 5, 10, 15, 20, 30, 50, 100, or 200%, with the percentage being based on the die height. (For convenience, the term “thickness” was chosen to denote the shortest dimension of the foam slab, while the term “height” was deemed more appropriate for the corresponding dimension of the die and die orifices used to produce the foam slab. All of these correspond to the up/down direction as pictured in FIG. 5). In particular embodiments, die orifices 10 may be arranged in a single row in which the height of the die orifices defines the die height (e.g., as in the exemplary embodiments of FIGS. 1 and 3-5). In various embodiments, the slab thickness of the foam may be greater than the orifice height, by a factor of at least about 2%, to at most about 5, 10, 15, 20, or 30%, with the percentage being based on the orifice height.

In various embodiments, a slab width of the foam slab may be at least (on average) from about plus 2%, to about plus 5, 10, 15, 20, 30, 50, or 100%, of the die width. In various embodiments the width of the foam slab may be at least about 1.1, 1.2, 1.5, 2, 4, 6, 8, or 10 times the slab thickness of the foam slab. In further embodiments the slab width may be at most about 400, 200, 100, 80, 60, 40, 20, or 10 times the slab thickness. In various embodiments the slab width may be at least about 2.0, 4.0, 8.0, 10, 20, 30, or 40 cm. In further embodiments, the slab width of the foam slab may be at most about 3, 2, 1, or 0.5 meters, or least about 100, 80, 60, 50, 40, 30, 25, or 20 cm. In various embodiments, the slab thickness of the foam slab may be at least about 4, 8, 12, 16, 20, 30, or 40 mm. In further embodiments, the slab thickness of the foam slab may be at most about 200, 160, 80, 40, 30, 25, or 20 mm. (All such values and ranges are for the foam slab as-produced; that is, before any cutting or trimming of the foam slab.) Although the discussions above have primarily focused on cases in which the thus-formed foam slab is at least slightly thicker than the die height, and/or is at least slightly wider than the lateral width of the die, this is not necessarily required to be the case. Indeed, depending on the particular characteristics of the foamable composition and the manner of processing the composition, the thus-formed foam slab may be e.g. similar to, or even slightly smaller in thickness and/or width, than the die height and/or die width (as evidenced by Working Example 3).

Determination of Lateral Alignment and Lateral Adjacency

By a laterally-aligned orifice pattern is meant that at least about 80% of the total orifice area of the working face of the die, is collectively provided by orifices that are each laterally adjacent to at least one other orifice. Whether a given die orifice is laterally adjacent to at least one other orifice can be determined by geometric inspection. Specifically, for a given die orifice (e.g. orifice 10a of FIG. 4) to be laterally adjacent to some other die orifice (e.g. orifice 10b of FIG. 4) means that locations along at least 80% of the height (along the height axis of the die) of the given orifice must be laterally adjacent to some other orifice. For any particular location along the vertical height of the given orifice to be laterally adjacent to some other orifice, a line that is extended from that location (specifically, from the near edge of the orifice at that location), along a direction aligned with the lateral axis of the die, must encounter a near edge of some other orifice within a distance of about 25 mm. (It is believed that an edge-to-edge distance (dₑ) between two orifices that is in this range may allow for satisfactory meeting and coalescence of the extrudate from the two orifices, under many extrusion/foaming conditions. However, the ordinary artisan will appreciate that material parameters and/or operating parameters (such as e.g. throughput, density, viscosity, crystallization rate, and so on) may somewhat affect the distance (dₑ) that allows satisfactory meeting and coalescence, in any particular circumstance.) Thus in the exemplary depiction of FIG. 4, the vertical centerpoint of orifice 10a is laterally adjacent to neighboring orifice 10b as long as the edge-to-edge distance (dₑ) is about 25 mm or less. In fact, in the design of FIG. 4, locations along at least essentially 100% of the vertical height of orifice 10a are laterally adjacent to orifice 10b. The same considerations apply to neighboring orifice 10c. Thus, given an edge-to-edge distance of about 25 mm or less, the arrangement of die orifices in FIGS. 3 and 4 thus represents an exemplary laterally-aligned pattern of die orifices. In various embodiments, the edge-to-edge distance between neighboring die orifices, may be, on average, less than about 20, 15, 10, 5, 2, or 1 mm. In various embodiments, the edge-to-edge distance between neighboring die orifices, may be, on average, at least about 0.1, 0.2, 0.5, 1, 2, or 4 mm.

In some embodiments, at least about 85, 90, or 100% of the total orifice area of the working face of the die, will be collectively provided by orifices that are each laterally adjacent to at least one other orifice. In some embodiments, at least about 80, 90, or 95% of the total orifice area of the working face of the die, will be collectively provided by orifices that are each laterally adjacent to at least two other orifices. In particular embodiments, all of the orifices except the laterally outwardmost orifices of the working face, will each be laterally adjacent to at least two other orifices (as in the exemplary design of FIG. 3, again assuming an edge-to-edge distance (dₑ) of about 25 mm or less).

In further embodiments, at least some die orifices may be closely laterally adjacent to other die orifices, meaning that the edge-to-edge distance as described above, is about 6 mm or less. Such orifices may thus form a closely laterally-aligned orifice pattern as long as at least about 80% of the total orifice area is collectively provided by orifices that are each closely laterally adjacent to at least one other orifice. In specific embodiments, at least some die orifices may be closely laterally packed, meaning that the edge-to-edge distance as described above, is about 4 mm or less. Such orifices may thus form a closely laterally-packed orifice pattern as long as at least about 80% of the total orifice area is collectively provided by orifices that are each closely laterally packed to at least one other orifice.

It is emphasized that FIGS. 3 and 4 are merely exemplary representations and that the above manner of evaluating whether a particular arrangement of orifices is laterally-aligned does not require that the orifices be arranged in a strictly uniform manner That is, the edge-to-edge distance between various orifices (likewise the center-to-center spacing between various orifices) may not necessarily be exactly the same. Moreover, as mentioned above, laterally-aligned merely requires that at least about 80% of the total orifice area of the working face of the die, is collectively provided by orifices that are laterally adjacent to at least one other orifice. Thus, a number of e.g. smaller die orifices, and/or orifices that do not have a long axis oriented at least substantially along the height axis of the die, and so on, may be provided in any desired location of the working face for any purpose, as long as the above conditions are met and as long as the orifice pattern is readily recognizable by the ordinary artisan as achieving the overall effect of forming a foam slab primarily by way of lateral coalescence of molten extruded flowstreams. In specific embodiments, at least about 90, 95, or at least essentially 100% of the total orifice area of the working face of the die may be collectively provided by orifices that are laterally-adjacent, closely laterally-adjacent, or are closely laterally packed, with respect to at least one other orifice.

In some embodiments, die orifices may be arranged in a single row, as in the exemplary embodiment pictured in FIGS. 3 and 4. In some embodiments a row may be comprised of orifices that are co-linear (as in FIGS. 3 and 4), meaning that the vertical centerpoints of all of the orifices fall at least essentially on a straight line that is aligned with the lateral axis of the die. (In this context, the vertical centerpoint of an orifice is the point that is midway between the “uppermost” and “lowermost” ends of the orifice, along the long axis of the orifice. Vertical centerpoints CPᵥ are indicated in FIG. 4.) In some embodiments, a set of orifices may be a staggered row, meaning that the vertical centerpoints of the sets of orifices are not co-linear. However, any set of orifices (e.g. an offset or staggered row) is still considered to be a single row as long as there is at least some lateral overlap between the orifices of the set (that is, if a straight line that is aligned with the lateral axis of the die can be drawn that passes through any portion of each of the orifices of the set). The degree of stagger of such a row can be gauged by the amount of lateral overlap between the orifices of the row, on average. This lateral overlap can be represented as the percentage of the vertical height of an orifice (along the height axis of the die) that laterally overlaps at least one other orifice (as evaluated by extending a straight line, along the lateral axis of the die, from points along the vertical height of the orifice to see whether the line contacts any other orifice). The lateral overlap of the exemplary arrangement of FIG. 3 is of course 100%. In other embodiments, the lateral overlap of a set of die orifices may be e.g. at least about 95, 90, 85, 80, 75, or 50%.

Any sets of orifices that do not exhibit the above-described lateral overlap may be considered to be two (or more) separate rows. Any suitable number of rows of orifices may be used as desired. However, in various particular embodiments, the number of rows may be less than four, less than three, or less than two (i.e., a single row as discussed above). One particular exemplary embodiment is shown in FIG. 6. In this embodiment, two rows of orifices (12 and 13) are provided, each of which comprises die orifices that are laterally adjacent as disclosed above (given an edge-to-edge distance of about 25 mm or less). Thus, the design of FIG. 6 meets the criteria of a laterally-aligned pattern of orifices as disclosed herein.

In the particular design of FIG. 6, the orifices of the two rows are provided as vertically-stacked sets (in this case, pairs), meaning that the orifices of a set are aligned with each other along the height axis of the die. Such designs will fall within the definition of a laterally-aligned orifice pattern, as long as the conditions outlined herein are met. It will be appreciated that in designs of the general type shown in FIG. 6, as the vertical distance between the upper edge of a lowermost orifice (e.g., orifice 10) of a vertically-stacked pair, and the lower edge of the uppermost orifice (e.g., orifice 10′) of the pair, is reduced, the vertically-stacked orifice pair will function more like a single orifice with a total height and overall aspect ratio provided by the two orifices in combination. Any suitable number of vertically-stacked orifices may be used. In various embodiments, a set of vertically-stacked orifices may comprise two (as in FIG. 6), three, or four orifices. In various embodiments, the vertical edge-to-edge distance between orifices of a vertically-stacked set of orifices may be, on average, no more than about 8, 4, 3, or 2 mm.

Foaming die 1 can be of any suitable construction, with orifices 10 provided in any desired manner. The width, height and spacing of the die orifices may be chosen (e.g. in combination with the length of the orifices along the direction of molten fluid flow through the orifices) as desired. It will be appreciated that these may be chosen in combination with e.g. the throughput of molten extrudate and other design and operating parameters, to provide that an appropriate pressure drop through the die orifices is achieved. That is, such parameters can be adjusted to provide that the molten foamable composition is maintained at a sufficiently high pressure within the die that at least a substantial amount of blowing agent that is present in the molten foamable composition does not expand prematurely (e.g., prior to molten foamable flowstream 1010 exiting die 1 through a die orifice 10). (Some amount of expansion of blowing agent within the die orifice may be tolerated as long as the desired properties of the foam product are achieved.)

Construction of Foaming Die

In this context it is noted that by definition a foaming die, in addition to being able to meet the usual requirements of extrusion (e.g. withstanding high temperatures, not exhibiting leakage of the molten polymeric flowstreams, and so on), must also withstand the process conditions that arise in a foaming process. Specifically, a foaming die must not exhibit leakage of an activated (e.g., gas or vapor) blowing agent (alternatively phrased, a foaming die must be able to maintain internal pressure sufficient to maintain the activated blowing agent in solution with the molten organic polymeric material) to a degree that unacceptably affects the ability to form a useful foam. A foaming die thus must possess an enhanced ability to prevent or minimize leakage of gases/vapors (in addition to liquid, molten flowstreams) therefrom. It is thus noted that a conventional extrusion die may not necessarily be able to be considered to be a foaming die, absent specific information that the die possesses such ability.

In some embodiments, orifices 10 may be through-openings that are provided in any desired manner (e.g. by electrodischarge machining, laser cutting, water cutting, and so on) e.g. in a sheet (which term is used broadly and does not require e.g. a strictly planar configuration). The sheet may be made of a suitable material (e.g., metal) and of suitable thickness to withstand the pressures and forces commensurate with foam extrusion. The thickness of such a sheet may be chosen (or, a specific area of the sheet in which an orifices is to be provided may e.g. have its thickness reduced by machining or cutting) so as to achieve a desired orifice length as noted above. To form a foaming die, such a sheet may be interfaced e.g. to a main body comprising one or more die cavities, in such manner that the orifices are in fluid communication with a die cavity so that a molten flowstream that is delivered to the die cavity (e.g. from at least one extruder) may be divided into multiple flowstreams that are then delivered to the die orifices.

In some embodiments, a foaming die 1 may be provided at least in part by a plurality of shims that are layered together under pressure to form a shim stack. In specific embodiments, each shim may exhibit a major plane that is at least substantially parallel to the height axis (h) of the foaming die. Such shims can combine to collectively define the die orifices of the foaming die, to define a main body of the foaming die, and also to define at least one die cavity (within the main body) that is fluidly connected to at least some of the die orifices. More details of shim-stack dies are found in the copending U.S. Provisional Patent Application Ser. No. 62/067,890 filed evendate with the present application, entitled Shim-Stack Foaming Die (attorney docket number 75788US002), which is incorporated by reference herein in its entirety.

Materials

Foaming die 1 may be used to process any suitable molten foamable composition, comprising any desired organic polymeric material in combination with any suitable blowing agent. Suitable organic polymers may be chosen from any thermoplastic (melt-extrudable) composition, encompassing e.g. one or more homopolymers, co-polymers (whether random, block, graft, and so on), mixtures or blends of various homopolymers or copolymers, and so on. In particular embodiments, any such polymers may be branched (e.g., in order to provide higher melt strength), if desired. Suitable organic polymers may be chosen from e.g. polyolefins, polyesters, polyacrylics, polyamides, polycarbonates, polyurethanes, polystyrenes, and so on. Any suitable additives may be included as long as such additives do not unacceptably interfere with the foaming ability of the composition. For example, one or more inorganic additives such as mineral fillers, reinforcing fillers, pigments or the like may be used (e.g., talc, silica, clay, titania, glass fibers, glass bubbles, platelets, nanoparticles, nanotubes, and so on). Other additives might include antioxidants, ultraviolet absorbers, chain extenders, anti-static agents, hindered amine light stabilizers, hydrolytic stabilizers, nucleating agents, processing aids, flame retardants, coloring agents, slip agents, and so on. Any of these additives may be used in any desired combination.

In some embodiments, the organic polymeric material may be a polyolefinic material. A non-limiting list of suitable polyolefin materials includes e.g. polypropylene, polyethylene, polybutylene, poly(4-methyl-1-pentene), and copolymers and blends of any of these.

In some embodiments, the organic polymeric material may be a polyester material. By “polyester” is meant any material in which at least about 70% by weight of the organic polymeric material is a homopolymer and/or copolymer having ester linkages. In various embodiments, ester-linkage polymer chains make up at least about 80%, at least about 90%, at least about 95%, at least about 98%, or at least 99.5% of the weight of the material. In various embodiments, the polyester is at least 70% by weight polyethylene terephthalate, at least 80% by weight polyethylene terephthalate, at least 90% by weight polyethylene terephthalate, or at least 95% by weight polyethylene terephthalate. In further embodiments, the polyester material consists essentially of polyethylene terephthalate, which condition will be understood as not precluding the presence of a small amount (e.g., less than about 2.0 mole %) of monomeric units derived from glycols other than ethylene glycol.

Suitable polyesters include e.g. those commonly made by condensation polymerization of hydroxyl-containing monomers and/or oligomers (e.g., chain extenders) with poly-acid-containing or poly-ester-containing monomers and/or oligomers (e.g., dicarboxylic acids or diesters such as terephthalic acid, isophthalic acid, naphthalene dicarboxylate, etc.). Such polyesters may be made from poly-acids, or from any ester-forming equivalents of such materials (e.g., from any materials that can be polymerized to ultimately provide a polyester). Such polyesters may be made from any suitable hydroxyl-containing chain extender or combination of extenders. Commonly used chain extenders include for example the two-carbon diol, ethylene glycol (2G, when polymerized with terephthalic acids or esters yielding polyester “2GT”); the three-carbon diol, 1,3 propanediol (3G, when polymerized with terephthalic acids or esters yielding polyester “3GT”); and the four-carbon diol 1,4 butanediol (4G, when polymerized with terephthalic acids or esters yielding polyester “4GT”). Other names in use for 2GT are polyethylene terephthalate or PET, for 3GT are trimethylene terephthalate (PTT) or polypropylene terephthalate (PPT) and for 4GT polybutylene terephthalate or PBT. Polyesters may be made e.g. from any suitable poly-acid-containing or poly-ester-containing monomers or oligomers or combination thereof. In some embodiments, such monomers or oligomers may be selected such that the resulting polyester is an aromatic polyester; in other embodiments, they may be selected such that the resulting polyester is an aliphatic polyester. Blends of any of the above polyesters (e.g., aliphatic with aromatic) may be used, as can aliphatic/aromatic copolymers.

Further details of polyesters that may be useful (not only for use in a foamable composition, but also in a densified, e.g. non-foamable, composition) are described in U.S. patent application Ser. No. 14/363,132, entitled “Methods of Bonding Polyester Substrates”, published on Feb. 19, 2015 as U.S. Patent Application Publication No. 2015/0047774, which is incorporated by reference in its entirety herein. In the particular instance in which a polyester is used in a foamable composition, it may be advantageous that the foamable composition include a chain extender (e.g. in order to enhance the melt strength of the molten composition). Often, anhydrides such as phthalic anhydride, maleic anhydride, or pyromellitic dianhydride (PMDA), and/or compounds such as certain aziridines, epoxides and diamines, are used for such purposes.

A molten foamable composition may include any suitable blowing agent (sometimes referred to as a foaming agent), in any effective amount. Such blowing agents are often broadly categorized as physical blowing agents (meaning molecules that undergo a physical phase change, e.g. volatilization or evaporation, without any chemical reaction) or as chemical blowing agents (in which a chemical reaction typically occurs to liberate a gaseous or volatile molecule). Non-limiting examples of physical blowing agents include various gases (e.g., argon, helium, nitrogen, carbon dioxide, etc.). Further examples include volatilizable liquids, including hydrocarbons such as various propanes, butanes, pentanes, heptanes, and so on. Such physical blowing agents may be e.g. injected under pressure (whether as a liquid or as a gas) into a polymer melt or incipient melt (e.g. in the barrel of an extruder). Non-limiting examples of chemical blowing agents include e.g. azodicarbonamide, oxybis (benzene sulfonylhydrazide), phenyl tetrazole, and alkali carbonates comprising e.g., sodium carbonate and/or sodium bicarbonate). Such agents may be e.g. inserted e.g. as a melt additive into the extruder, premixed with the organic polymeric material that is desired to be extruded, etc. Mixtures of any blowing agents, of any type, may be used as desired. In various embodiments, a blowing agent (or combination of two or more blowing agents) may be present in a foamable composition, at a level of at least about 0.1, 0.5, 1.0, 2.0, or 4.0 weight percent, to at most about 20, 15, 10, 8.0, or 6.0 weight percent.

Extrusion Apparatus

Foaming die 1 may be used with any suitable extrusion apparatus. One exemplary extrusion apparatus is depicted in FIG. 2. Foaming die 1 by definition will comprise at least one die cavity that is configured to receive a molten foamable flowstream, e.g. comprising a molten foamable composition. An extruder may be used to deliver the molten foamable flowstream to the die cavity of die 1. This may be done via a gear pump 512 and/or via a feedblock 513 if desired (thus, the concept of a die cavity receiving a molten flowstream from an extruder, encompasses cases in which e.g. a gear pump and/or a feedblock or any other ancillary equipment is used to deliver the flowstream from the extruder outlet to the die cavity). Often in extrusion involving a foamable composition, it may be convenient to use an extrusion apparatus comprising two extruders in tandem, in which a first extruder 511 (operating e.g. at a relatively high compression ratio) is used to melt a desired composition and to deliver the melted composition (whether directly, or through a gear pump, and so on) to a second extruder 510, which second extruder (operating e.g. at a relatively low compression ratio) may primarily perform a metering and/or cooling function. In some embodiments, an extrusion apparatus may comprise two extruders (or two pairs of tandem extruders), operated in parallel e.g. so as to provide different molten compositions to different die cavities, as discussed in further detail later herein.

If desired, an extrusion apparatus may include one or more blowing agent input ports 514 which may be used to inject one or more blowing agents into the molten or incipiently molten composition so that the composition becomes a foamable composition. Although shown as located on extruder 514 in the exemplary embodiment of FIG. 2, such a blowing agent input port may be located at any suitable position of an extrusion apparatus (e.g. along the length of an extruder; or, if a tandem extruder setup is used, along the length of either extruder or between the extruders).

In at least some embodiments, foaming die 1 may be configured to continuously emit molten foamable extrudate flowstreams 1010 into an undefined space (as shown in FIG. 2) that is not an interior of a molding cavity. That is, in such embodiments the extrusion/coalescing process is a continuous process that produces a continuous foam slab 1100 rather than being e.g. an injection-molding operation in which molten foamable composition is periodically delivered in batches into an injection molding cavity (that is e.g. completely bounded on all sides except for e.g. one or more sprues, gates or the like). Thus in some embodiments die 1 may be used to extrude a molten extrudate into “open air”, the coalesced streams then being collected e.g. on a moving belt (not shown in any Figure). However, if desired, one or more forming plates may be provided e.g. proximate one or both major surfaces of the incipient foam slab e.g. to enhance the production of the foam slab as an at least generally rectangular slab with relatively smooth major surfaces. If desired, the molten extrudate may be delivered into a space between two moving belts (e.g. into a so-called double-belt press) which may enhance the smoothness of the surface of the foam slab and/or may control the thickness of the foam slab as desired. The use of forming plates (sometimes referred to in the art as calibrators) or a double-belt press is distinguished from batchwise injection molding into a cavity. In particular embodiments, no forming plate or plates, or double-belt press, is used with die 1.

The environment into which the molten extrudate/incipient foam is emitted may be controlled in any way that appropriately affects the rate or amount of expansion of the incipient foam, the growth/coalescence/collapse of the cells of the incipient foam, and so on. Suitable parameters may include e.g. the overall pressure, the concentration of particular gases within a gaseous environment into which the molten extrudate is emitted, and/or the temperature of such an environment. Thus, for example, if the molten extrudate is collected on a takeaway belt or between two belts of a dual-belt lamination, the temperature of the belt(s) may be controlled as desired. Or, the temperature of an air (or in general, gaseous) environment into which the molten extrudate is emitted may be controlled as desired.

The orientation of die 1 (that defines the direction along which the molten streams are extruded, e.g. into an undefined space), can be any direction as desired. That is, the extrusion does not necessarily have to occur in a purely horizontal direction, or a purely vertical direction, with respect to the Earth. It is emphasized that the use herein of terms such as vertical, height, uppermost, lowermost, and so on, are for convenience of description with regard to e.g. FIGS. 3-5, and does not imply any particular orientation with regard to the Earth.

Lamination

In some embodiments, a substrate (e.g., a sheetlike substrate) may be laminated to a major surface of unitary foam slab 1100. This may be done in any suitable fashion, using any desired lamination method, e.g. by the use of an adhesive or the like. In specific embodiments, it may be advantageous to perform such lamination in-line, meaning that a substrate is laminated to slab 1100 substantially immediately after slab 1100 is generated by coalescence of flowstreams 1010, by the use of a laminating apparatus that is physically co-located in-line with die 1 and extrusion apparatus. This may be contrasted to e.g. a scheme in which slab 1100 is produced and then stored until such time as the slab is moved to a lamination apparatus to laminate a substrate thereto. While any suitable bonding method may be used, such in-line lamination may advantageously be performed before slab 1100 has completely cooled and/or solidified, so as to e g enhance melt-bonding between the substrate (which itself may be heated to facilitate the bonding process) and a major surface of slab 1100. In some embodiments, at least a major surface of slab 1100 and a major surface of a substrate that is to be bonded to the surface of slab 1100, are melt-bondable to each other. Further aspects of melt-bondable materials are discussed elsewhere herein, in a discussion of major and minor phases of a composite foam slab. These discussions and lists of exemplary materials will not be included here for brevity, but should be regarded as likewise applicable to the materials of any substrate that might be laminated to a major surface of foam slab 1100.

Any desired substrate may be laminated to any foam slab, as desired. Suitable substrates may be chosen from e.g. metal foils, metal meshes, inorganic fibrous webs such as fiberglass or rockwool, and so on. In some embodiments, a substrate to be laminated may be an organic polymeric substrate. In particular embodiments, such a substrate may be a fibrous material, e.g. a fabric, nonwoven web, woven or knitted web, scrim or netting, and so on, of any suitable composition. In some embodiments, such a substrate may be a fibrous material that is pre-impregnated with a reactive material (e.g., it may be a glass-fiber substrate that comprises a “pre-preg” such as an epoxy). In some embodiments, a substrate may be an organic polymeric film or sheet (including e.g. a fiber-reinforced film or sheet) of any suitable composition. In particular embodiments, such a film may be a polyester film, e.g. a biaxially-oriented polyester film. In specific embodiments, a polymer film that is to be laminated to a foam slab may be a flashlamped film. Details of processes by which films may be flashlamped are presented in detail in U.S. patent application Ser. No. 14/363,132, entitled “Methods of Bonding Polyester Substrates”, published on Feb. 19, 2015 as U.S. Patent Application Publication No. 2015/0047774, which is incorporated by reference in its entirety herein.

In some embodiments, a unitary foam slab to which a substrate is laminated, may be a unitary composite foam slab comprising at least a major, foam phase and a minor, densified phase that may be e.g. made of a non-foam material, as discussed in detail below. In some embodiments, the minor phase of such a composite foam slab may take the form of one or more elongate members as described herein. In some embodiments, the minor phase of such a composite foam slab may take the form of at least a first (and optionally a second) surface layer to which the substrate is laminated. It may be particularly advantageous that such a surface layer function e.g. as a tie layer to which a particular substrate may be more easily bonded than it might be bonded to the foam phase. For example, in specific embodiments, a tie layer comprising e.g. glycol-modified polyethylene terephthalate may be used, e.g. when a polyethylene terephthalate major foam phase (layer) is to have a polyethylene terephthalate substrate (e.g., film or nonwoven web) laminated thereto. In some embodiments, a first substrate may be laminated (e.g., in-line laminated via melt-bonding) to a first major surface of slab 1100, and a second substrate may be similarly laminated to a second major surface of slab 1100.

Composite Foam Slabs

In some embodiments, the apparatus and methods disclosed herein may be used to make composite foam slabs that comprise a major, foam phase and a minor, densified phase as defined previously. In some embodiments, the die orifices of die 1 may include a first set of die orifices that are fluidly connected to a first die cavity of die 1 that is configured to receive a first molten flowstream comprising a first molten composition that is a foamable composition; and, a second set of die orifices that are fluidly connected to a second die cavity of die 1 that is configured to receive a second molten flowstream comprising a second molten composition. In some embodiments, the first and second molten compositions may be essentially identical (e.g., a single foamable composition delivered to both die cavities by the same extruder or pair of tandem extruders), that is processed through first and second die cavities and sets of die orifices e.g. in order to be able to more finely control the extrusion process. In other embodiments, the first and second molten compositions may differ from each other e.g. so as to make a foam slab that is a composite foam slab. In such embodiments, the second molten composition may be supplied to the second die cavity (and thus to the second set of die orifices) from a second extruder that is different from the first extruder (or tandem extruder pair), as shown in the exemplary arrangement of FIG. 2. In such arrangements, the first die orifices may be used e.g. to produce a major, foam phase of a composite foam slab and the second die orifices may be used e.g. to produce a minor, densified phase of the composite foam slab.

In some embodiments of this general type, a second set of die orifices can be provided in an arrangement in which at least selected die orifices of the second set are each individually laterally sandwiched between a pair of die orifices of the first set of die orifices. An exemplary arrangement of this type is shown in FIG. 8, in which second die orifices 10_{f} are each individually laterally sandwiched between a pair of first die orifices 10_{f}. By this terminology is meant that a single second die orifice 10ₛ is positioned laterally between two first die orifices 10_{f} which first die orifices 10_{f} do not have any orifice laterally between them except for the second die orifice 10ₛ. In the exemplary arrangement of FIG. 8, the first die orifices 10_{f} are all generally dogbone shaped, and the second die orifices 10ₛ are generally oval or rectangular in shape and are also slightly shorter in height than the first die orifices 10_{f}. It will be appreciated however that the die orifices of FIG. 8 still meet the criteria of a laterally-aligned pattern of die orifices.

Such arrangements may provide composite foam slabs comprising densified (e.g., non-foam) elongate members that extend continuously along the long axis of the slab and that are spaced apart across at least a portion of the width of the foam slab, as discussed in detail later herein. As discussed below, in some embodiments the second die orifices may emit a densified extrudate, e.g. a non-foamable composition, e.g. in order to provide elongate members that are in the form of reinforcing beams or rails. Such a composition may not necessarily laterally expand to the extent that a foamable composition (that is e.g. emitted from the first die orifices) will expand. In consideration of this, the spacing between any second orifice and the first orifices that laterally sandwich it, may be reduced as desired to ensure that sufficient lateral coalescence is achieved. Moreover, the height of the second orifices (along the height axis of the die) may be chosen relative to the height of first orifices, as desired, e.g. to provide that any such elongate members are “buried” within the foam layer of the composite foam slab; or, conversely, to provide that an elongate member provides at least a portion of a major surface of the composite foam slab. The spacing and/or number of first orifices that are provided between any two second orifices, may be chosen e.g. to achieve a desired spacing of the elongate members across the width of the thus-formed foam slab.

In some embodiments, composite foam slabs may be made that comprise a minor phase in the form of a surface layer (e.g., a densified surface layer such as a non-foam surface layer) that extends continuously along the long axis of the slab and that may extend at least generally, substantially, or essentially, across the lateral width of at least one major surface of the foam slab. This may be achieved e.g. by an arrangement in which at least some of the die orifices 10 of die are in fluid communication with a die cavity that is configured to receive a multilayer molten flowstream. This may be arranged e.g. by the use of multiple extruders (e.g. extruders 510 and 515 as depicted in FIG. 2) that deliver flowstreams to a feedblock 513 that is a multilayer feedblock that can combine the flowstreams in layers into a multilayer flowstream as will be well understood by the ordinary artisan. For example, with reference to FIG. 2, extruder 510 may deliver a primary molten flowstream comprising a primary molten composition, extruder 515 may deliver a secondary molten flowstream comprising a secondary molten composition, and multilayer feedblock 513 may combine the flowstreams into a multilayer flowstream that is delivered to a die cavity of die 1, which die cavity then divides the multilayer flowstream into multiple multilayer flowstreams that are distributed to die orifices.

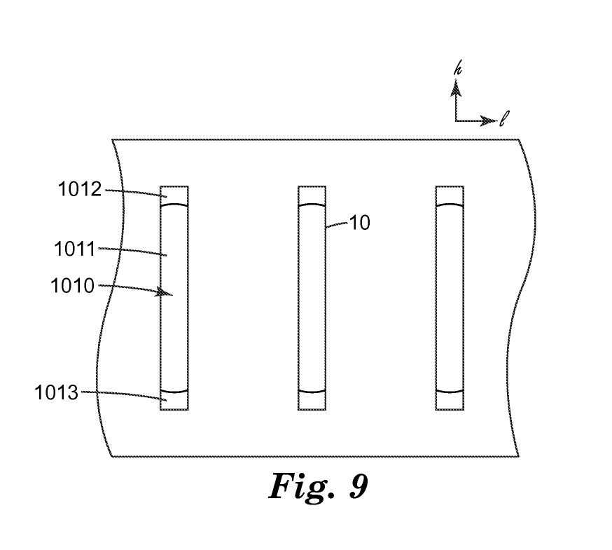

FIG. 9 shows an exemplary embodiment in which multilayer molten flowstreams 1010 are emitted from three die orifices 10. Flowstreams 1010 are vertically-stacked multilayer flowstreams, with each multilayer flowstream 1010 comprising a primary molten layer 1011 that provides at least a vertically central layer of the multilayer flowstream; and, a first secondary molten layer 1012, and a second secondary molten layer 1013, with the first and second secondary molten layers being outer layers that vertically sandwich primary molten layer 1011. As is pictured in the specific illustrative embodiment of FIG. 9, the multilayer flowstreams emitted from the different die orifices may be at least substantially identical in the composition and positioning of the respective layers (e.g., they may be fed from the same die cavity). Or, different die orifices may emit multilayer flowstreams that differ e.g. in the placement and/or thickness of the layers, in the composition of at least one of the layers, or in any combination of these parameters.

It will be appreciated that upon extrusion of multilayer flowstreams of this general type, the primary molten layers and the secondary molten layers within each multilayer flowstream can be allowed to solidify as a unitary mass (that is, to melt-bond to each other). This process may occur in addition to the already-described foaming and lateral coalescence, e.g. in order to form a unitary composite slab that may comprise a minor phase in the form of e.g. at least one sheet-like layer that extends continuously along the long axis of the slab. Depending e.g. on the presence of any other die orifices (e.g. that may emit a single-layer flowstream of the same composition as primary molten layer 1011), the minor phase may or may not extend continuously across the lateral width of the slab. In many embodiments, a sheet-like layer may extend continuously across at least 80, 90, 95, or 98%, or essentially the entire lateral width, of the slab (in addition to extending continuously along the long axis of the slab).

It will be appreciated that although FIG. 9 depicts an exemplary embodiment in which the orifices are straight, rectangular orifices, “dogbone” style orifices (e.g. of the general type depicted in FIG. 7) may be used if desired. This may advantageously help outer secondary molten layers 1012 and 1013 to spread laterally to respectively form surface layers that each extend e.g. continuously across the lateral width of the slab (particularly in the event that these flowstream layers are e.g. a non-foamable composition that might not spread as much laterally as does a foamable composition of central layer 1011). The particular illustration of FIG. 9 depicts an illustrative embodiment in which two secondary molten layers are present. However, in other embodiments, only a single secondary molten layer may be used, e.g. if it is desired to provide a minor phase in the form of a sheet-like layer only on one major surface of a foam slab.

It will be appreciated that in some embodiments, a sheet-like minor phase might be provided, not by way of vertically-stacked multilayer flowstreams, but rather by the use of one or more orifices that is separate from the orifices that deliver molten foamable flowstreams, which separate orifice(s) delivers a secondary molten layer, e.g. a densified layer, e.g. a non-foamable layer. Such an orifice or orifices might be provided in the working face of a foaming die similar to that shown in FIG. 3, e.g. as an orifice or orifices positioned above and/or or below the plurality of orifices 10 and that comprises a long axis that extends at least substantially along the lateral axis of die 1, e.g. across the entire die width (W_{d}). Or, a separate die with a separate orifice or orifices may be positioned with its working face vertically above or below the working face of die 1, for such purpose.

In embodiments of the general type depicted in FIG. 9, a primary molten layer 1011 will comprise a primary molten composition and a secondary molten layer 1012 (and 1013 if present) will comprise a secondary molten composition. In some embodiments, a primary molten composition may be a foamable composition and a secondary molten composition may be a densified composition. (Strictly speaking, the higher density may not come into effect until the solidification is completed; however, for convenience of description, a molten composition, flowstream, or layer of a flowstream, that solidifies to provide a densified minor phase of a composite foam slab, will be described by the term densified.) It is thus noted that the terminology of a molten foamable flowstream (e.g. flowstream 1010 of FIG. 9) does not require that the flowstream must consist solely of a foamable composition. Rather, the term molten foamable flowstream encompasses multilayer molten flowstreams and allows (in some embodiments) the presence of some other molten layer (e.g. a densified layer, e.g. a non-foamable layer) in the flowstream.

A secondary molten composition of a multilayer flowstream (or a second molten composition emitted through a second set of orifices) may differ in any desired manner from a first or primary (foamable) molten composition e.g. in order to achieve a desired effect. For example, a second or secondary molten composition may be a densified composition based on a molten organic polymeric material that is similar or identical to that found in a first or primary molten composition, but comprising a lower amount of blowing agent so as to provide a lessened degree of foaming and thus to provide a minor, densified phase of the resulting composite foam slab. Again, it is emphasized that the term densified does not signify or require any particular absolute density but merely denotes a minor phase with a relative density that is at least about 15% higher than that of the major, foam phase of a composite foam slab (as discussed above, the term also denotes a molten composition that can form such a minor phase when solidified). In fact, under some circumstances a blowing agent might be able to penetrate (e.g., diffuse) from a primary molten composition into a secondary molten composition with which the primary molten composition is in contact, so as to cause the formation of at least some cells in the minor, densified phase of the resulting foam slab.

This nuance notwithstanding, in some embodiments a second or secondary composition may be a non-foamable composition, meaning a composition that, as made, is essentially free of active blowing agent (which concept encompasses a circumstance in which a blowing agent is present but in which the molten composition is extruded under conditions (e.g., a sufficiently low temperature) such that essentially none of the blowing agent is activated). Such a non-foamable composition, when solidified, may often exhibit a relative density of at least essentially 1.0 (throughout at least a portion of the minor, densified phase of the thus-formed foam slab), as noted earlier herein. In specific embodiments, a second or secondary molten composition is a non-foamable composition comprising a molten organic polymeric material that is at least substantially identical to the molten organic polymeric material of a first or primary foamable molten composition, but that includes essentially no blowing agent. In other embodiments, the second or secondary molten composition differs chemically from the first or primary (foamable) molten composition. In some embodiments such differences may be relatively minor, which may advantageously promote or enhance the ability of the compositions to intermingle and/or physically or chemically bond to each other during a coalescing process.

The discussions above have presented embodiments in which a densified composition may be included in a molten flowstream so as to provide a minor phase in a resulting unitary composite foam slab. In a first exemplary embodiment, a minor phase may be present as elongate members, e.g. as reinforcing rails; in a second exemplary embodiment, a minor phase may be present e.g. as one or more sheet-like surface layers. (In some embodiments minor phases of both types may be present.) In general in any such embodiments, a densified composition may be chosen to be melt-bondable with a foamable composition with which it is used, if desired. The term melt-bondable as applied to two compositions signifies that when the compositions are brought together in a molten condition (e.g. by the coalescence of extruded molten flowstreams) they will exhibit acceptable melt-bonding at interfaces therebetween (regardless of whether such bonding occurs e.g. primarily by way of polymer entanglements, polar forces, hydrogen-bonding, hydrophobic interactions, and so on). In some embodiments, melt-bondable polymeric materials may be capable of forming a miscible blend with each other. Examples of such materials include e.g. certain polyethylene terephthalates with other polyethylene terephthalates (e.g. of slightly different molecular weight and/or copolymer composition, that comprise different additive packages, and so on); polyethylene terephthalates with polybutylene terephthalates; and polyethylene terephthalates with glycol-modified polyethylene terephthalates. Other material pairs will be known to be melt-bondable with each other, e.g. polyphenylene oxides with polystyrenes, and polymethyl methacrylates with polyvinylidene fluorides.

In particular embodiments, a polyester that is used to form a minor phase of a composite foam slab, may be a glycol-modified polyester (often referred to by acronym PET-G). Such a polymer may be provided e.g. by using a chain extender such as e.g. cyclohexane dimethanol in place of at least some portion of another chain extender such as ethylene glycol. This may alter the material's crystallization properties in such a way as to enhance the ability of the material to melt-bond. Such a material will often be melt-bondable with polyethylene terephthalate, and thus may be able to coalesce with, and bond very well to, a foamable composition comprising polyethylene terephthalate.

The apparatus and methods disclosed herein may be used to make foam slabs, e.g. laterally-coalesced unitary foam slabs and laterally-coalesced unitary composite foam slabs. A laterally-coalesced foam slab may be identified e.g. by way of interfacial boundaries 1102 (with shown in exemplary, idealized representation in FIG. 5) that demarcate locations at which the lateral surfaces of neighboring flowstreams met each other (such a meeting-point 1103 is shown in FIG. 5) and bonded to each other. Such foam slabs are discussed in detail in copending U.S. Provisional Patent Application Ser. No. 62/067,896 filed evendate with the present application, entitled Laterally-Coalesced Foam Slab (attorney docket number 75789US002), which is incorporated by reference herein in its entirety.

### LIST OF EXEMPLARY EMBODIMENTS

Embodiment 1 is a foaming die for extruding a molten foamable composition, comprising: a working face comprising a plurality of laterally-aligned die orifices spaced along a lateral axis of the foaming die so as to define a die width and a die height, wherein the die orifices each exhibit an elongated shape with a long axis that is oriented at least substantially orthogonal to the lateral axis of the foaming die and that is at least substantially aligned with a height axis of the foaming die, wherein the die orifices each exhibit an orifice height to orifice width aspect ratio of at least about 4:1.

Embodiment 2 is the foaming die of embodiment 1 wherein the ratio of the die width to the die height is at least about 4:1. Embodiment 3 is the foaming die of embodiment 1 wherein the die orifices exhibit an orifice height to orifice width aspect ratio of at least about 8:1. Embodiment 4 is the foaming die of any of embodiments 1-3 wherein all of the die orifices of the foaming die are at least essentially aligned with the height axis of the die, and are at least essentially co-linearly, uniformly spaced along the lateral axis of the foaming die. Embodiment 5 is the foaming die of any of embodiments 1-4 wherein the die orifices are spaced in a single row along the lateral axis of the foaming die. Embodiment 6 is the foaming die of any of embodiments 1-4 the die orifices are co-linearly spaced in a single row along the lateral axis of the foaming die and wherein all of the die orifices comprise at least essentially identical heights, which heights define the die height of the foaming die.

Embodiment 7 is the foaming die of any of embodiments 1-6 wherein the foaming die is provided at least in part by a plurality of shims that are layered together under pressure to form a shim stack, each shim exhibiting a major plane that is at least substantially parallel to a thickness axis of the foaming die, the shims combining to collectively define the die orifices of the foaming die and to define at least one die cavity that is fluidly connected to the die orifices. Embodiment 8 is the foaming die of any of embodiments 1-7 wherein the foaming die is fluidly coupled to an extrusion apparatus that comprises at least one extruder and that is configured to continuously supply a molten foamable flowstream to at least one die cavity of the foaming die. Embodiment 9 is the foaming die of embodiment 8 wherein the extrusion apparatus comprises first and second extruders fluidly connected to each other in tandem. Embodiment 10 is the foaming die of any of embodiments 1-9 wherein the foaming die is configured to continuously emit molten foamable extrudate flowstreams comprising at least the molten foamable composition, into an undefined space that is not an interior of an injection molding cavity.

Embodiment 11 is the foaming die of any of embodiments 1-10 wherein the plurality of die orifices includes a first set of die orifices that are fluidly connected to a first die cavity that is configured to receive a first molten flowstream from an extruder, and a second set of die orifices that are fluidly connected to a second die cavity that is configured to receive a second molten flowstream from an extruder. Embodiment 12 is the foaming die of embodiment 11 wherein the first die cavity is configured to receive the first molten flowstream from a first extruder, and wherein the second die cavity is configured to receive the second molten flowstream from a second extruder that is different from the first extruder. Embodiment 13 is the foaming die of embodiment 12 wherein at least selected die orifices of the second set of die orifices are each individually laterally sandwiched between pairs of die orifices of the first set of die orifices. Embodiment 14 is the foaming die of any of embodiments 1-13 wherein at least some die orifices of the plurality of die orifices are in fluid communication with a die cavity that is configured to receive a multilayer molten flowstream from a multilayer feedblock, which multilayer feedblock is configured to receive molten flowstreams from at least two different extruders and to combine the molten flowstreams into the multilayer molten flowstream.

Embodiment 15 is the foaming die of any of embodiments 1-14 wherein the at least some of the die orifices each comprise a dogbone shape in which a width of the orifice in a location proximate a first terminal end of the orifice, and a width of the orifice in a location proximate a second terminal end of the orifice that is generally opposite the first terminal end of the orifice, are each larger than a width of the orifice in a section of the orifice that is centrally located along the long axis of the orifice. Embodiment 16 is the foaming die of any of embodiments 1-15 wherein a center-to-center spacing of the laterally-aligned die orifices is at most about 15 mm. Embodiment 17 is the foaming die of any of embodiments 1-15 wherein a center-to-center spacing of the laterally-aligned die orifices is at most about 10 mm. Embodiment 18 is the foaming die of any of embodiments 1-15 wherein a center-to-center spacing of the laterally-aligned die orifices is at most about 5 mm.

Embodiment 19 is a method of making a unitary foam slab, comprising: continuously emitting molten foamable extrudate flowstreams through at least selected die orifices of a plurality of die orifices of a foaming die, wherein the die orifices are laterally-aligned and are spaced along a lateral axis of the foaming die so as to define a die width and a die height, wherein the die orifices each exhibit an elongated shape with a long axis that is oriented at least substantially orthogonal to the lateral axis of the foaming die and each exhibit an orifice height to orifice width aspect ratio of at least about 4:1; and, allowing the molten foamable extrudate flowstreams to foam and to coalesce and solidify as a unitary mass so as to form a unitary foam slab with a slab width and a slab thickness.

Embodiment 20 is the method of embodiment 19, wherein the foaming die comprises at least one die cavity that continuously receives a molten foamable flowstream from an extrusion apparatus and that divides the molten foamable flowstream into molten foamable flowstreams that are continuously delivered to the die orifices to be emitted therefrom as the molten foamable extrudate flowstreams. Embodiment 21 is the method of any of embodiments 19-20, wherein: the plurality of die orifices includes a first set of die orifices and a second set of die orifices, wherein at least selected die orifices of the second set of die orifices are each individually laterally sandwiched between pairs of die orifices of the first set of die orifices; and, wherein the method comprises continuously emitting first molten foamable extrudate flowstreams through the first set of die orifices, continuously emitting second molten extrudate flowstreams through the second set of die orifices, allowing the first molten foamable extrudate flowstreams to foam, allowing the first and second molten extrudate flowstreams to laterally coalesce with each other, and allowing the coalesced first and second molten extrudate flowstreams to solidify as a unitary mass to form a unitary composite foam slab. Embodiment 22 is the method of embodiment 21 wherein the second molten extrudate flowstreams comprise a densified molten composition. Embodiment 23 is the method of embodiment 21, wherein the second molten extrudate flowstreams consist essentially of a molten non-foamable composition.

Embodiment 24 is the method of any of embodiments 19-23, wherein at least some of the molten foamable extrudate flowstreams are vertically-stacked multilayer flowstreams, each multilayer flowstream comprising a primary molten layer that comprises a molten foamable composition and that provides at least a vertically central layer of the multilayer flowstream, and a secondary molten layer that provides an outer layer of the multilayer flowstream, and wherein the method includes allowing the primary molten layers and the secondary molten layers of the multilayer flowstreams to solidify as a unitary mass to form a unitary composite foam slab; wherein the unitary composite foam slab comprises a major, foam layer that is derived from the primary molten layer, and a minor, surface layer that is derived from the secondary molten layer of the multilayer flowstream and that is a sheet-like layer that provides a major outer surface of the composite foam slab, and wherein the major, foam layer and the minor, surface layer each extend continuously across the width of the foam slab and along the length of the foam slab. Embodiment 25 is the method of embodiment 24 wherein the secondary molten layer of the multilayer flowstream comprises a densified molten composition. Embodiment 26 is the method of embodiment 24, wherein the secondary molten layer of the multilayer flowstream comprises a molten non-foamable composition and wherein the minor, surface layer of the composite foam slab consists essentially of a non-foam layer.

Embodiment 27 is the method of any of embodiments 19-23, wherein at least some of the molten foamable extrudate flowstreams are vertically-stacked multilayer flowstreams, each multilayer flowstream comprising a primary molten layer that comprises a molten foamable composition and that provides a vertically central layer of the multilayer flowstream, a first secondary molten layer that provides a first outer layer of the multilayer flowstream, a second secondary molten layer that provides a second outer layer of the multilayer flowstream, and wherein the method includes allowing the primary molten layers and the first and second secondary layers of the multilayer flowstreams to solidify as a unitary mass to form a unitary composite foam slab; wherein the unitary composite foam slab comprises a major, foam layer that is derived from the primary molten layer and that provides a vertically central layer of the foam slab; and, first and second minor, surface layers that are respectively derived from the first and second secondary molten layers of the multilayer flowstream and that are sheet-like layers that each provide a major outer surface of the unitary composite foam slab, and wherein the major, foam layer and the first and second minor, surface layers each extend continuously across the width of the foam slab and along the length of the foam slab. Embodiment 28 is the method of embodiment 27 wherein the first and second secondary molten layers each comprise a densified molten composition. Embodiment 29 is the method of embodiment 27, wherein the first and second secondary molten layers each comprise a molten non-foamable composition and wherein the first and second minor, outer surface layers of the composite foam slab each consist essentially of a non-foam layer. Embodiment 30 is the method of embodiment 27 wherein the primary molten layer consists essentially of a molten foamable composition.

Embodiment 31 is the method of any of embodiments 19-30 wherein the molten foamable extrudate flowstreams are continuously emitted into an undefined space that is not an interior of an injection molding cavity. Embodiment 32 is the method of any of embodiments 19-30 wherein the method further includes continuously in-line laminating a first substrate to a first major outer surface of the unitary foam slab. Embodiment 33 is the method any of embodiments 19-30 wherein the method further includes continuously in-line laminating a second substrate to a second, opposing major outer surface of the unitary foam slab. Embodiment 34 is the method of any of embodiments 19-33, using the foaming die of any of embodiments 1-18.

### EXAMPLES

### Representative Working Example

A shim-stack foaming die was assembled of the general type described in copending U.S. Provisional Patent Application Ser. No. 62/067,890 filed evendate with the present application, entitled Shim-Stack Foaming Die (attorney docket number 75788US002). The foaming die had 50 laterally-aligned, elongated orifices that were spaced across the lateral width of the thus-formed foaming die in a single row, in generally similar manner as depicted in FIGS. 1 and 3, each with an orifice width (Wₒ) of 16 mils and with an orifice height (Hₒ) of 625 mils. Rather than using single orifice shims (of thickness 16 mils) to provide this orifice width, orifice shim bundles were used, each bundle comprised of 4 orifice shims of 4 mils thickness. Spacer shims were used to space the orifices at an edge-to-edge distance (dₑ) of approximately 60 mils (thus providing a center-to-center orifice distance (dₑ) of 76 mils). Rather than single spacer shims being used, spacer shim bundles were used, each bundle being comprised of three 20 mil shims.

The shim-stack foaming die thus had a total of 347 shims (200 total orifice shims in 50 bundles of 4 shims each, and 147 total spacer shims in 49 bundles of 3 shims each), defining 50 die orifices in all; a first set of 25 orifices in fluid communication with a first die cavity and a second set of 25 orifices in fluid communication with a second die cavity. In this Representative Working Example a molten foamable flowstream was only fed to the first die cavity (and from there to the first set of 25 “active” die orifices to which that die cavity was fluidly connected). It will thus be understood that each pair of nearest-neighbor active die orifices was interspersed by an inactive (unused) die orifice through which no molten extrudate was emitted. (Strictly speaking, in this mode of operation each pair of active die orifices was spaced apart not purely by spacer shims, but also by orifice shims that provided an inactive die orifice therebetween.)

Thus in summary, the foaming die defined 25 active die orifices, that were arranged at an edge-to-edge spacing of approximately 136 mils (and a center-to-center spacing of approximately 152 mils) to provide an active die width W_{d} of approximately 3.74 inches. (The orifice height Hₒ and die height H_{d} were not affected by the fact that only one of the die cavities was used).

All shims were made of stainless steel that had been EDM (electrodischarge machining) cut to the desired shape and to provide cutouts as desired. All shims were held together by four bolts passed through cutouts in the shim-stack. These bolts were tightened with as much torque as possible using an air powered torque wrench. Edge heaters were coupled to the top and bottom of the die. Thermocouples were used for temperature monitoring in customary fashion.

A foamable composition was prepared, comprising thermoplastic polyester (PET) resin (POLYCLEAR 1101; Auriga, Charlotte, N.C.) at 95 wt. %, a chemical blowing agent (Sukano TA17-10; Duncan, S.C.) at 2 wt. %, and a chain extender (Sukano Tme S606) at 3 wt. %. The foamable composition was loaded into the hopper of a 1.25″ single screw extruder and was extruded under the conditions listed in Table 1:

TABLE 1

| Parameter | Value |
|---|---|
| Screw RPM | 68.1 |
| Zone 1 (F) | 432 |
| Zone 2 (F) | 540 |
| Zone 3 (F) | 547 |
| Adapt (F) | 494 |
| Necktube (F) | 510 |
| Die (F) | 500 |
| Die edge heaters (F) | 520 |
| Pressure (psi) | 2200 |

The die was oriented with its lateral axis approximately horizontal to the Earth surface. A takeaway belt was positioned a few centimeters below the working face of the die, oriented approximately horizontal to the Earth surface. The die was oriented so that the direction of flow of molten extrudate out of the die orifices was angled slightly downward (at an angle of approximately 15 degrees below horizontal) toward the upper surface of the takeaway belt so that the molten extrudate was collected on the takeaway belt. The takeaway belt speed was approximately 0.6 feet per minute. Under these conditions, the coalescence distance (Dₑ) was estimated to be within a few (e.g. 1-3) mm of the working face of the die. The thus-formed laterally-coalesced unitary foam slab exhibited approximate (average) values of 0.35 g/cc density, 5.8 inch width, and 1.3 inch thickness.

### Working Example 2

A shim-stack foaming die was used of the general type described in the Representative Working Example, except that the die with had fifty active orifices, each 24 mils in width and 625 mils in height. Rather than using single orifice shims, orifice shim bundles were used, each bundle comprising six orifice shims of 4 mils thickness. Spacer shims were used to space the orifices at an edge-to-edge distance (dₑ) of approximately 80 mils (thus providing a center-to-center orifice distance (d_{c}) of 104 mils). Rather than single spacer shims being used, spacer shim bundles were used, each bundle being comprised of four shims of 20 mil thickness.

This die design had a total of 496 shims and was 5.1 inches wide. Two foamable compositions were prepared, each of the same composition as for the Representative Example. The foamable compositions were each loaded into a hopper of a 1.25″ single screw extruder; two such extruders were used, one feeding a first die cavity and first die orifice set, the second feeding a second die cavity and second die orifice set. Thus, in this Example, all die orifices were active orifices and all were fed the same molten foamable composition (although from two different extruders.)

The two compositions were extruded under the conditions listed in Table 2 (the extruders were not identical in configuration so they were operated at somewhat different conditions):

TABLE 2

| Parameter | Extruder #1 | Extruder #2 |
|---|---|---|
| Screw RPM | 58.1 | 29 |
| Zone 1 (F) | 436 | 460 |
| Zone 2 (F) | 519 | 520 |
| Zone 3 (F) | 539 | 540 |
| Adapt (F) | 513 | 520 |
| Necktube (F) | 490 | 476 |
| Pressure (psi) | 2600 | 4000 |

| | |
|---|---|
| Die (F) | 480 |
| Die edge heaters (F) | 480 |

The takeaway belt speed was approximately 0.6 feet per minute. Under these conditions, the coalescence distance (D_{c}) was estimated to be within a few (e.g. 1-3) mm of the working face of the die. The thus-formed laterally-coalesced unitary foam slab exhibited approximate (average) values of 0.36 g/cc density, 5.5 inch width, and 1.4 inch thickness.

### Working Example 3

The shim-stack foaming die of Working Example 2 was used. Two identical foamable compositions were prepared, each comprising high melt strength polypropylene (Borealis WB140HMS; Vienna, Austria) at 98 wt. %, and a chemical blowing agent (Reedy FPE-50; Charlotte, N.C.) at 2 wt. %. The foamable compositions were each loaded into a hopper of one of two 1.25″ single screw extruders, each extruder feeding a different die cavity, in the same manner as in Working Example 2.

The two compositions were extruded under the conditions listed in Table 3:

TABLE 3

| Parameter | Extruder #1 | Extruder #2 |
|---|---|---|
| Screw RPM | 83.4 | 80.2 |
| Zone 1 (F) | 350 | 350 |
| Zone 2 (F) | 430 | 430 |
| Zone 3 (F) | 433 | 400 |
| Adapt (F) | 370 | 370 |
| Necktube (F) | 370 | 360 |

| | |
|---|---|
| Die (F) | 340 |
| Die edge heaters (F) | 340 |

| | | |
|---|---|---|
| Pressure (psi) | 2000 | 2400 |

The takeaway belt speed was approximately 0.6 feet per minute. Under these conditions, the coalescence distance (D_{c}) was estimated to be within a few (e.g. 1-3) mm of the working face of the die. The thus-formed laterally-coalesced unitary foam slab exhibited approximate (average) values of 0.54 g/cc density, 3.8 inch width, and 0.6 inch thickness.

### Working Example 4

A shim-stack foaming die was assembled of the type described in the Representative Working Example, except that the die with had fifty active orifices, each 16 mils in width and 625 mils in height. Rather than using single orifice shims, orifice shim bundles were used, each bundle comprised four orifice shims of 4 mils thickness. Spacer shims were used to space the orifices at an edge-to-edge distance (dₑ) of approximately 60 mils (thus providing a center-to-center orifice distance (d_{c}) of 76 mils). Rather than single spacer shims being used, spacer shim bundles were used, each bundle being comprised of three shims of 20 mil thickness.

This die design had a total of 347 shims and was 3.74 inches wide. A first, foamable composition was prepared, of the same composition as in the Representative Working Example. A second composition was prepared, that was PET-G (polyethylene terephthalate-glycol modified; EASTAR Copolyester 6763, Eastman Chemical, Kingsport, Tenn.). The second composition was not a foamable composition. The first and second compositions were respectively fed to first and second 1.25″ extruders, and were processed under the conditions listed in Table 4:

TABLE 4

| | 1^{st} Extruder/ | 2nd Extruder/ |
|---|---|---|
| Parameter | composition | composition |
| Screw RPM | 102 | 15.2 |
| Zone 1 (F) | 442 | 480 |
| Zone 2 (F) | 540 | 500 |
| Zone 3 (F) | 538 | 500 |
| Adapt (F) | 484 | 500 |
| Necktube (F) | 518 | 474 |
| Pressure (psi) | 3800 | 2400 |

| | |
|---|---|
| Die (F) | 480 |
| Die edge heaters (F) | 500 |

The takeaway belt speed was approximately 0.6 feet per minute. Under these conditions, the coalescence distance (D_{c}) was estimated to be within a few (e.g. 1-3) mm of the working face of the die. The thus-formed laterally-coalesced unitary composite foam slab exhibited approximate (average) values of 0.32 g/cc density, 5.8 inch width, and 0.75 inch thickness.

### Working Example 5

A shim-stack foaming die was assembled of the type described in the Representative Working Example. A single 1.25″ extruder was used to feed the same foamable composition as in the Representative Working Example, to a single cavity and die set of the die, in the same manner as in the Representative Working Example. The foamable composition was processed under the conditions listed in Table 5:

TABLE 5

| Parameter | Value |
|---|---|
| Screw RPM | 102 |
| Zone 1 (F) | 450 |
| Zone 2 (F) | 517 |
| Zone 3 (F) | 500 |
| Adapt (F) | 500 |
| Necktube (F) | 520 |
| Die (F) | 490 |
| Die edge heaters (F) | 500 |
| Pressure (psi) | 3000 |

The molten extrudate was taken away on a dual belt laminator (Meyer KFE-E 1500; Meyer GmbH, Rötz, Germany), running at 2.5 ft/min. The lower belt extended slightly toward the working face of the die and was positioned a few cm below the working face so that the molten extrudate was collected on the lower belt and then carried into the gap between the lower belt and the upper belt. Two biaxially oriented PET films were unwound into the dual belt laminator so that the molten extrudate/incipient foam was sandwiched between upper and lower PET films, with a PET film being laminated to each major surface of the resulting PET foam. The surface of each PET film that was contacted with the molten extrudate had been flashlamped in the general manner disclosed in U.S. patent application Ser. No. 14/363,132, entitled “Methods of Bonding Polyester Substrates”.

The dual-belt laminator was operated under the conditions listed in Table 6:

TABLE 6

| Parameter | Value |
|---|---|
| Belt height (mm) | 12 |
| Internal nip (mm) | 1.5 |
| Laminator Zone 1 (C) | 190 |
| Laminator Zone 2 (C) | 120 |
| Laminator Zone 3 (C) | 23 |

The belt height is the separation distance between the top and bottom belts of the dual belt laminator. The dual belt laminator has an internal nip approximately halfway in its length. The internal nip parameter is defined as the amount the nip is compressing the belts. For example a belt height of 10 mm sets the gap at 10 mm, and with a 1 mm internal nip setting, the gap at the nip is then set to 9 mm.

The thus-formed laterally-coalesced unitary foam slab exhibited approximate (average) values of 0.40 g/cc density (of the foam core), 6.0 inch width, and 0.25 inch thickness (having been constrained by the belts of the dual-belt laminator, from expanding to the same degree as in e.g. the Representative Working Example).

### Working Example 6

A shim-stack foaming die was assembled of the type described Working Example 4. First and second compositions of the same compositions as in Working Example 4, were processed by way of first and second extruders. However, rather than the first and second flowstreams feeding different die cavities/sets of die orifices, the first (foamable) molten flowstream and the second (non-foamable, PET-G) molten flowstream were combined at a common inlet to the die to form a multilayer flowstream comprising an inner layer (akin to layer 1011 of FIG. 9) that was a foamable composition, and upper and lower layers (akin to layers 1012 and 1013 of FIG. 9) of PET-G. The first and second compositions were processed, with the resulting molten extrudate being collected in a dual-belt laminator along with top and bottom layers of flashlamped PET film (in similar manner as in Working Example 5), under the conditions listed in Table 7:

TABLE 7

| | 1^{st} Extruder/ | 2^{nd} Extruder/ |
|---|---|---|
| | composition | composition |
| Screw RPM | 90 | 22 |
| Zone 1 (F) | 437 | 450 |
| Zone 2 (F) | 511 | 505 |
| Zone 3 (F) | 539 | 530 |
| Adapt (F) | 517 | 500 |
| Necktube (F) | 511 | 511 |
| Pressure (psi) | 2740 | 3350 |

| | |
|---|---|
| Die (F) | 480 |
| Die edge heaters (F) | 500 |
| Belt speed (ft/min) | 1.65 |
| Zone 1 top (° C.) | 140 |
| Zone 1 bottom (° C.) | 130 |
| Zone 2 top (° C.) | 140 |
| Zone 2 bottom (° C.) | 130 |
| Belt Height (mm) | 11.5 |
| Internal nip (mm) | 1 |

The flashlamped PET films were thus laminated to PET-G surface layers that were present on each major surface of the thus-formed foam slab. The thus-formed laterally-coalesced unitary composite foam slab (bearing PET films laminated thereto) exhibited approximate (average) values of 0.45 g/cc density (of the foam core), 3.0 inch width, and 0.375 inch thickness.

### Working Example 7

A shim-stack foaming die was assembled of the type described in the Representative Working Example. A foamable composition was prepared, comprising high melt strength polypropylene (Borealis WB140HMS) at 96 wt. %, and a chemical blowing agent (EcoCell Chemical Blowing Agent; Polyfil, Rockaway, N.J.) at 4 wt. %. The foamable composition was processed under the conditions listed in Table 8:

TABLE 8

| Parameter | Value |
|---|---|
| Screw RPM | 100 |
| Zone 1 (F) | 350 |
| Zone 2 (F) | 420 |
| Zone 3 (F) | 400 |
| Adapt (F) | 400 |
| Necktube (F) | 390 |
| Die (F) | 390 |
| Die edge heaters (F) | 390 |
| Pressure (psi) | 3680 |

The molten extrudate was taken away on a dual belt laminator (Meyer KFE-E 1500), running at 2.7 ft/min. The lower belt extended slightly toward the working face of the die and was positioned a few cm below the working face so that the molten extrudate was collected on the lower belt and then carried into the gap between the lower belt and the upper belt. Two glass-fiber-reinforced polypropylene (GFPP) films were unwound into the dual belt laminator so that the molten extrudate/incipient foam was sandwiched between upper and lower GFPP films, with each GFPP film laminated to a major surface of the molten extrudate. (The GFPP films had been made using Borealis Fibremod GB306SAF (35 wt. % glass fibers) resin pellets in standard cast film extrusion equipment (single screw extruder, 3-roll casting station, and winder.)

The thus-formed laterally-coalesced unitary foam slab (with GFPP films laminated thereto) exhibited approximate (average) values of 0.50 g/cc density (of the foam core), 2.5 inch width, and 0.375 inch thickness.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document incorporated by reference herein, this specification as written will control.

1. A foaming die for extruding a molten foamable composition, comprising,
a working face comprising a plurality of laterally-aligned die orifices spaced along a lateral axis of the foaming die so as to define a die width and a die height,
wherein the die orifices each exhibit an elongated shape with a long axis that is oriented at least substantially orthogonal to the lateral axis of the foaming die and that is at least substantially aligned with a height axis of the foaming die,
wherein the die orifices each exhibit an orifice height to orifice width aspect ratio of at least about 4:1.

2. (canceled)

3. The foaming die of claim 1 wherein the die orifices exhibit an orifice height to orifice width aspect ratio of at least about 8:1.

4-5. (canceled)

6. The foaming die of claim 1 the die orifices are co-linearly spaced in a single row along the lateral axis of the foaming die and wherein all of the die orifices comprise at least essentially identical heights, which heights define the die height of the foaming die.

7. The foaming die of claim 1 wherein the foaming die is provided at least in part by a plurality of shims that are layered together under pressure to form a shim stack, each shim exhibiting a major plane that is at least substantially parallel to a thickness axis of the foaming die, the shims combining to collectively define the die orifices of the foaming die and to define at least one die cavity that is fluidly connected to the die orifices.

8. The foaming die of claim 1 wherein the foaming die is fluidly coupled to an extrusion apparatus that comprises at least one extruder and that is configured to continuously supply a molten foamable flowstream to at least one die cavity of the foaming die.

9. The foaming die of claim 8 wherein the extrusion apparatus comprises first and second extruders fluidly connected to each other in tandem.

10. The foaming die of claim 1 wherein the foaming die is configured to continuously emit molten foamable extrudate flowstreams comprising at least the molten foamable composition, into an undefined space that is not an interior of an injection molding cavity.

11. The foaming die of claim 1 wherein the plurality of die orifices includes a first set of die orifices that are fluidly connected to a first die cavity that is configured to receive a first molten flowstream from an extruder, and a second set of die orifices that are fluidly connected to a second die cavity that is configured to receive a second molten flowstream from an extruder.

12. The foaming die of claim 11 wherein the first die cavity is configured to receive the first molten flowstream from a first extruder, and wherein the second die cavity is configured to receive the second molten flowstream from a second extruder that is different from the first extruder.

13. (canceled)

14. The foaming die of claim 1 wherein at least some die orifices of the plurality of die orifices are in fluid communication with a die cavity that is configured to receive a multilayer molten flowstream from a multilayer feedblock, which multilayer feedblock is configured to receive molten flowstreams from at least two different extruders and to combine the molten flowstreams into the multilayer molten flowstream.

15. The foaming die of claim 1 wherein the at least some of the die orifices each comprise a dogbone shape in which a width of the orifice in a location proximate a first terminal end of the orifice, and a width of the orifice in a location proximate a second terminal end of the orifice that is generally opposite the first terminal end of the orifice, are each larger than a width of the orifice in a section of the orifice that is centrally located along the long axis of the orifice.

16. The foaming die of claim 1 wherein a center-to-center spacing of the laterally-aligned die orifices is at most about 15 mm.

17. The foaming die of claim 1 wherein a center-to-center spacing of the laterally-aligned die orifices is at most about 10 mm.

18. The foaming die of claim 1 wherein a center-to-center spacing of the laterally-aligned die orifices is at most about 5 mm.

19. A method of making a unitary foam slab, comprising:
continuously emitting molten foamable extrudate flowstreams through at least selected die orifices of a plurality of die orifices of a foaming die,
wherein the die orifices are laterally-aligned and are spaced along a lateral axis of the foaming die so as to define a die width and a die height,
wherein the die orifices each exhibit an elongated shape with a long axis that is oriented at least substantially orthogonal to the lateral axis of the foaming die and each exhibit an orifice height to orifice width aspect ratio of at least about 4:1;
and,
allowing the molten foamable extrudate flowstreams to foam and to coalesce and solidify as a unitary mass so as to form a unitary foam slab with a slab width and a slab thickness.

20. The method of claim 19, wherein the foaming die comprises at least one die cavity that continuously receives a molten foamable flowstream from an extrusion apparatus and that divides the molten foamable flowstream into molten foamable flowstreams that are continuously delivered to the die orifices to be emitted therefrom as the molten foamable extrudate flowstreams.

21. The method of claim 19, wherein:
the plurality of die orifices includes a first set of die orifices and a second set of die orifices, wherein at least selected die orifices of the second set of die orifices are each individually laterally sandwiched between pairs of die orifices of the first set of die orifices;
and,
wherein the method comprises continuously emitting first molten foamable extrudate flowstreams through the first set of die orifices, continuously emitting second molten extrudate flowstreams through the second set of die orifices, allowing the first molten foamable extrudate flowstreams to foam, allowing the first and second molten extrudate flowstreams to laterally coalesce with each other, and allowing the coalesced first and second molten extrudate flowstreams to solidify as a unitary mass to form a unitary composite foam slab.

22. The method of claim 21 wherein the second molten extrudate flowstreams comprise a densified molten composition.

23. The method of claim 21, wherein the second molten extrudate flowstreams consist essentially of a molten non-foamable composition.

24. The method of claim 19, wherein at least some of the molten foamable extrudate flowstreams are vertically-stacked multilayer flowstreams, each multilayer flowstream comprising a primary molten layer that comprises a molten foamable composition and that provides at least a vertically central layer of the multilayer flowstream, and a secondary molten layer that provides an outer layer of the multilayer flowstream, and wherein the method includes allowing the primary molten layers and the secondary molten layers of the multilayer flowstreams to solidify as a unitary mass to form a unitary composite foam slab;
wherein the unitary composite foam slab comprises a major, foam layer that is derived from the primary molten layer, and a minor, surface layer that is derived from the secondary molten layer of the multilayer flowstream and that is a sheet-like layer that provides a major outer surface of the composite foam slab, and wherein the major, foam layer and the minor, surface layer each extend continuously across the width of the foam slab and along the length of the foam slab.

25. The method of claim 24 wherein the secondary molten layer of the multilayer flowstream comprises a densified molten composition.

26. The method of claim 24, wherein the secondary molten layer of the multilayer flowstream comprises a molten non-foamable composition and wherein the minor, surface layer of the composite foam slab consists essentially of a non-foam layer.

27. The method of claim 19, wherein at least some of the molten foamable extrudate flowstreams are vertically-stacked multilayer flowstreams, each multilayer flowstream comprising a primary molten layer that comprises a molten foamable composition and that provides a vertically central layer of the multilayer flowstream, a first secondary molten layer that provides a first outer layer of the multilayer flowstream, a second secondary molten layer that provides a second outer layer of the multilayer flowstream, and wherein the method includes allowing the primary molten layers and the first and second secondary layers of the multilayer flowstreams to solidify as a unitary mass to form a unitary composite foam slab;
wherein the unitary composite foam slab comprises a major, foam layer that is derived from the primary molten layer and that provides a vertically central layer of the foam slab; and, first and second minor, surface layers that are respectively derived from the first and second secondary molten layers of the multilayer flowstream and that are sheet-like layers that each provide a major outer surface of the unitary composite foam slab, and wherein the major, foam layer and the first and second minor, surface layers each extend continuously across the width of the foam slab and along the length of the foam slab.

28-33. (canceled)
